(19) United States
(12) Patent Application Publication
(10) Pub. No.: US 2025/0378605 A1
(43) Pub. Date: Dec. 11, 2025

(54) ALLOCATION METHOD OF VIDEO IMAGES AND COMPUTING APPARATUS

(71) Applicant: Wistron Corporation, New Taipei City (TW)

(72) Inventors: Sheng Tang Lin, New Taipei City (TW); Chen Chung Ho, New Taipei City (TW); Kuan Jui Yao, New Taipei City (TW); Shih Min Chien, New Taipei City (TW); Jhih Wei Huang, New Taipei City (TW)

(73) Assignee: Wistron Corporation, New Taipei City (TW)

(21) Appl. No.: 18/779,101

(22) Filed: Jul. 22, 2024

(30) Foreign Application Priority Data
Jun. 6, 2024 (TW) 113121125

(51) Int. Cl. G06T 11/60; G06T 7/70; G06V 10/74

(52) U.S. Cl. CPC G06T 11/60; G06T 7/70; G06V 10/761; G06V 2201/07

(57) ABSTRACT

An allocation method of video images and a computing apparatus are provided. A plurality of video images are obtained. The video images correspond to a plurality of target objects. A detection result corresponding to the target objects is obtained. At least one target image is selected from the video images according to the detection result. A final image is generated according to the target image. The final image is used to be presented on a user interface. In this way, the screen content can be adjusted according to the situation.

### CROSS-REFERENCE TO RELATED APPLICATION

This application claims the priority benefit of Taiwan application serial no. 113121125, filed on Jun. 6, 2024. The entirety of the above-mentioned patent application is hereby incorporated by reference herein and made a part of this specification.

### BACKGROUND

### Technical Field

The disclosure relates to a video processing technology, and in particular, to an allocation method of video images and a computing apparatus.

### Description of Related Art

Video conferencing allows people in different locations or spaces to have conversations, and video conferencing related equipment, protocols, and/or applications have developed quite maturely as well. It is worth noting that in the interface of video conferencing software, the real-time image captured by the camera is displayed in a specific area of the screen most of the time. In real situations, there may be multiple people participating in a meeting in the same space. However, the real-time image is limited only by the field of view of the lens, and there are no other changes to the software screen.

### SUMMARY

The disclosure provides an allocation method of video images and a computing apparatus capable of providing flexible switching among image allocations.

An embodiment of the disclosure provides an allocation method of video images, and the method includes the following steps. A plurality of video images corresponding to a plurality of target objects are obtained. A detection result corresponding to the target objects is obtained. At least one target image is selected from the video images according to the detection result. A final image is generated according to the target image. The final image is used to be presented on a user interface.

An embodiment of the disclosure further provides a computing apparatus including a storage device and a processor. The storage device stores a program code. The processor is coupled to the storage device. The processor loads the program code and is configured to obtain a plurality of video images corresponding to a plurality of target objects, obtain a detection result corresponding to the target objects, select at least one target image from the video images according to the detection result, and generate a final image according to the at least one target image. The final image is used to be presented on a user interface.

To sum up, in the allocation method of the video images and the computing apparatus provided by the embodiments of the disclosure, the target image in the final image is determined based on the detection result of the target objects. In this way, the content allocation of the real-time image in the user interface is adjusted adaptively.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1A is a block diagram of components of a video conferencing system according to an embodiment of the disclosure.

FIG. 1B is a schematic view of a video conference according to an embodiment of the disclosure.

FIG. 2 is a flow chart of an allocation method of video images according to an embodiment of the disclosure.

FIG. 3 is a schematic view illustrating a first allocation according to an embodiment of the disclosure.

FIG. 4 is a flow chart illustrating switching from the first allocation to a second allocation according to an embodiment of the disclosure.

FIG. 5 is a schematic view illustrating a general allocation according to an embodiment of the disclosure.

FIG. 6 is a schematic view illustrating the second allocation according to an embodiment of the disclosure.

FIG. 7 is a flow chart illustrating switching from the first allocation to a third allocation according to an embodiment of the disclosure.

FIG. 8 is a schematic view illustrating the third allocation according to an embodiment of the disclosure.

FIG. 9 is a flow chart illustrating switching from the second allocation to the first allocation according to an embodiment of the disclosure.

FIG. 10 is a flow chart illustrating switching from the second allocation to the third allocation according to an embodiment of the disclosure.

FIG. 11 is a flow chart illustrating switching from the third allocation to the first allocation according to an embodiment of the disclosure.

FIG. 12 is a flow chart illustrating switching from the third allocation to the second allocation according to an embodiment of the disclosure.

### DESCRIPTION OF THE EMBODIMENTS

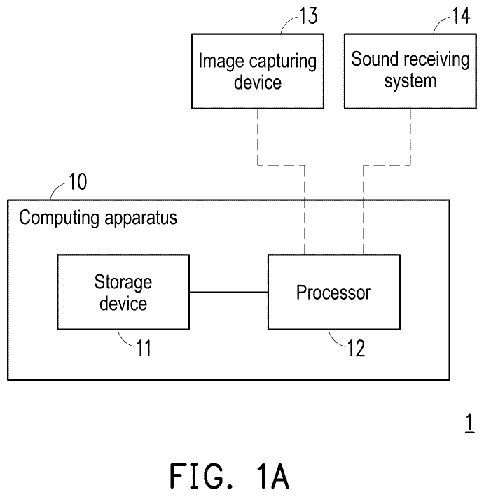

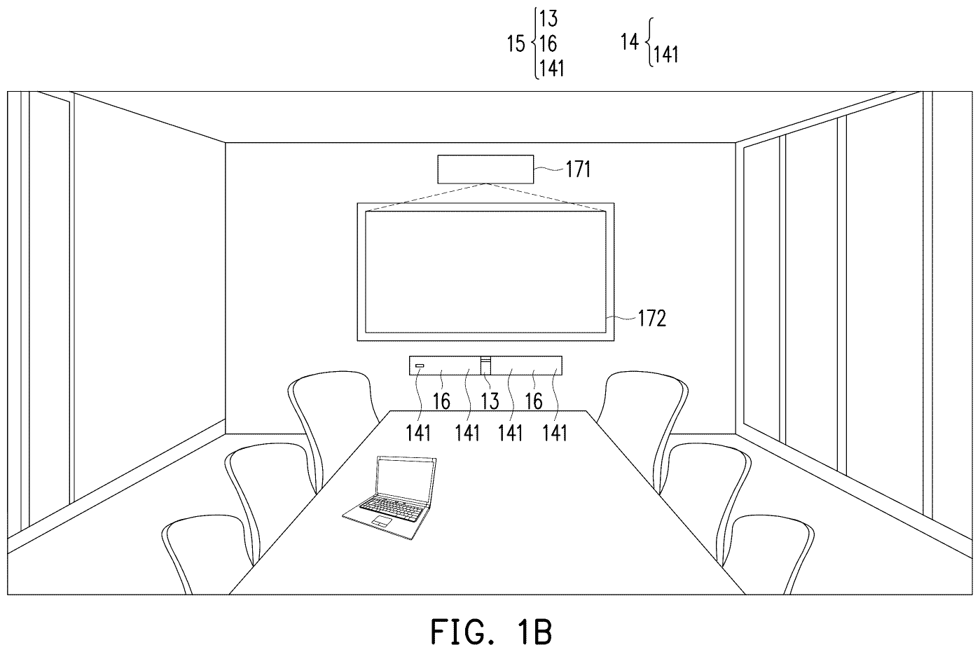

FIG. 1A is a block diagram of components of a video conferencing system 1 according to an embodiment of the disclosure. With reference to FIG. 1A, the video conferencing system 1 includes but not limited to a computing apparatus 10.

The computing apparatus 10 may be a mobile phone, an Internet phone, a tablet computer, a desktop computer, a laptop computer, an intelligent assistant apparatus, a wearable apparatus, a vehicle system, a smart home appliance, or other apparatuses.

The computing apparatus 10 includes but not limited to a storage device 11 and a processor 12.

The storage device 11 may be a fixed or movable random-access memory (RAM) in any form, a read only memory (ROM), a flash memory, a hard disk drive (HDD), a solid-state drive (SSD), or other similar devices. In an embodiment, the storage device 11 is used to store program codes, software modules, configurations, data (e.g., frames, images, or configurations of image regions), or files.

The processor 12 is coupled to the storage device 11. The processor 12 may be a central processing unit (CPU), a graphic processing unit (GPU), or a programmable microprocessor for general or special use, a digital signal processor (DSP), a programmable controller, a field programmable gate array (FPGA), an application-specific integrated circuit (ASIC), other similar devices, or a combination of the foregoing devices. In an embodiment, the processor 12 is used to execute all or part of the operations of the computing apparatus 10 and may load and execute one or a plurality of software modules, files, and/or data stored in the storage device 11.

In an embodiment, the video conferencing system 1 further includes one or a plurality of image capturing devices 13. The image capturing device 13 may be coupled to or communicatively connected to the processor 12. The image capturing device 13 may be a camera, a video recorder, or a webcam. In an embodiment, the image capturing device 13 is used to capture images within a field of view.

In an embodiment, the video conferencing system 1 further includes a sound receiving system 14. The sound receiving system 14 may be coupled to or communicatively connected to the processor 12. The sound receiving system 14 includes one or a plurality of microphones. The microphones may be dynamic microphones, condenser microphones, electret condenser microphones, or other types of microphones. In an embodiment, the plurality of microphones may be combined into a microphone array.

FIG. 1B is a schematic view of a video conference according to an embodiment of the disclosure With reference to FIG. 1B, in one application scenario, a sound bar 15 includes the image capturing device 13, four microphones 141, and speakers 16. The processor 12 may execute a video conferencing program (e.g., Teams, Zoom, Webex, or Meet). These microphones 141 form a microphone array. The processor 12 may receive sound waves through the microphones 141, convert them into sound signals, and capture a real-time image through the image capturing device 13. The processor 12 may capture a shared screen (e.g., a presentation, document, video, or picture screen), play a sound signal through the speaker 16, and/or present the real-time image on a screen 172 through a projector 171 or on its screen through a display (not shown). The sound signal, the real-time image, and/or shared screen may be transmitted to another computer apparatus (not shown) via the network through a communication transceiver (e.g., a transceiver circuit that supports a wired network such as Ethernet, optical fiber network, or cable, or a transceiver circuit that supports a wireless network such as Wi-Fi, fourth generation (4G), fifth generation (5G), or later generation mobile network). Alternatively, the processor 12 obtains the sound signal, the real-time image, and/or the shared screen via the network.

It should be noted that the arrangement position of the sound bar 15 shown in FIG. 1B is only an example and there may be other variations. The arrangement position of the sound bar 15 is not limited thereto. For instance, the sound bar 15 is placed above the screen 172 or on a desktop.

In the following paragraphs, a method provided by the embodiments of the disclosure is described together with the various apparatuses, devices, and modules in FIG. 1A and FIG. 1B. The steps of the method may be adjusted according to actual implementation and are not limited thereto.

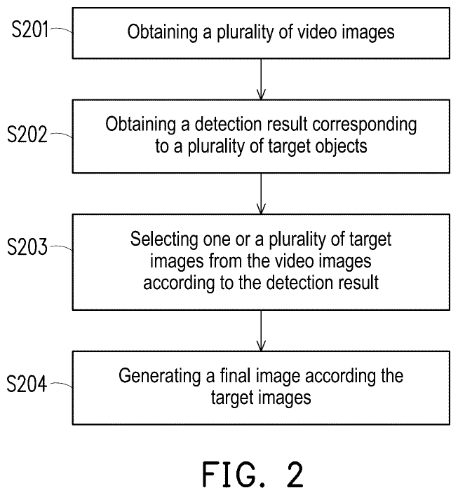

FIG. 2 is a flow chart of an allocation method of video images according to an embodiment of the disclosure. With reference to FIG. 2, the processor 12 obtains a plurality of video images (step S201). To be specific, the video images correspond to a plurality of target objects. In an embodiment, the target objects may be humans, dogs, cats, machines, or parts thereof.

In an embodiment, one image capturing device 13 captures a specified or adjustable field of view. The processor 12 identifies the target objects in the real-time image captured by the image capturing device 13 based on an object detection technology. For instance, the processor 12 may implement object detection using a machine learning-based algorithm (e.g., You only look once (YOLO), region based convolutional neural networks (R-CNN), or fast CNN (R-CNN)) or a feature matching-based algorithm (e.g., feature matching of histogram of oriented gradient (HOG), scale-invariant feature transform (SIFT), Haar, or speeded up robust features (SURF)). The results of object detection include a bounding box or a region of interest (ROI) of the target objects in the real-time image (representing the image region occupied by the target objects in the real-time image). The processor 12 may crop an image region corresponding to one or more target objects from the real-time image to form a video image. For instance, the cropped image region is a video image. Alternatively, the processor 12 may cut out a plurality of designated image regions from the real-time image and form a video image accordingly. For instance, the image regions corresponding to the expected appearance of the target objects in the real-time image is cropped.

In another embodiment, multiple image capturing devices 13 capture designated or adjustable fields of view individually. These fields of view may cover multiple target objects or locations where the target objects are expected to appear. The real-time images captured by these image capturing devices 13 may be individually used as a plurality of video images.

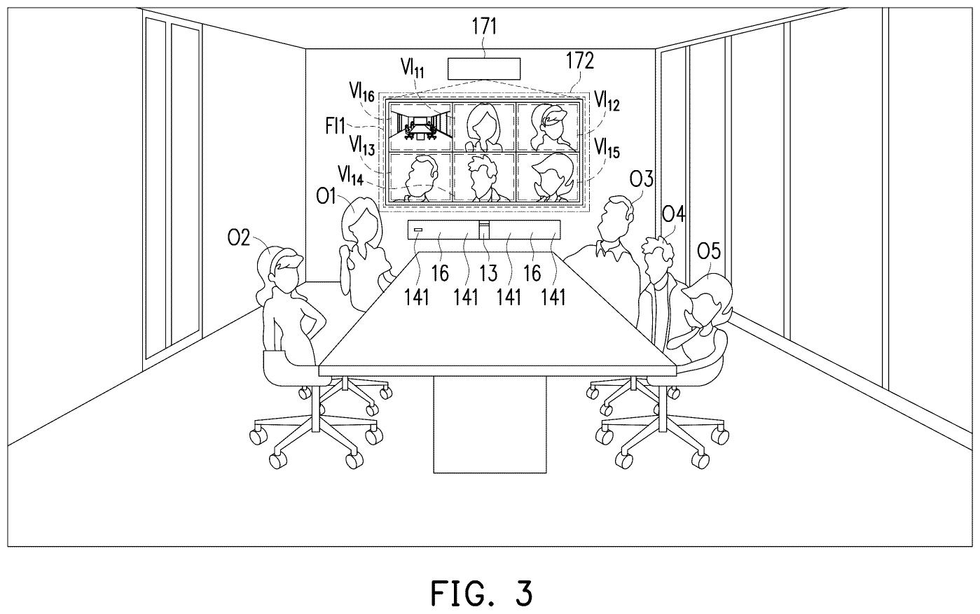

For instance, FIG. 3 is a schematic view illustrating a first allocation according to an embodiment of the disclosure. With reference to FIG. 3, the target objects are people's faces. This application scenario has five faces O1, O2, O3, O4, and O5. Video images VI₁₁, VI₁₂, VI₁₃, VI₁₄, and VI₁₅ correspond to faces O1 to O5, respectively. The video image VI₁₆ presented on the screen 172 (which may also be a display screen or a projection screen) is a real-time image of the field of view as shown in the figure. The video images VI₁₁, VI₁₂, VI₁₃, VI₁₄, and VI₁₅ displayed on the screen 172 may be cut out by the video image VI₁₆. Alternatively, the video images VI₁₁ to VI₁₅ are captured by different image capturing devices 13.

With reference to FIG. 2, the processor 12 obtains a detection result corresponding to a plurality of target objects (step S202). In an embodiment, the processor 12 may obtain the sound signal through the sound receiving system 14. For instance, sound waves generated by human voices, environmental sounds, and machine operation sounds are converted into sound signals. The processor 12 may detect the sound of the target objects from the sound signal and generate a detection result accordingly.

In an embodiment, the detection result includes location information. The location information may be a direction and/or a relative distance. The processor 12 may determine the location information corresponding to a sound source of the sound signal. The sound source is one of the target objects.

In an embodiment, the processor 12 may estimate a direction of the target object relative to the sound receiving system 14 based on an angle of arrival (AOA or degree of arrival, DOA) positioning technology. For instance, the processor 12 may determine the direction based on time difference between two sound waves detected when the sound signal is reflected by the target object and reaches the two microphones and a distance between the two microphones.

In another embodiment, the processor 12 may form beams with multiple directional angles through the multiple microphones in the sound receiving system 14. These microphones may form beams based on the beamforming technology. Beamforming may be achieved by adjusting parameters (e.g., phase and amplitude) of basic units of a phase array, so that signals at specific angles interfere constructively, while signals at other angles interfere destructively, and different beam patterns (for example, the directional angles of their main beams may be different) are formed accordingly. The processor 12 may obtain signal power obtained by beam sound receiving at multiple directional angles and determine the direction of the target object relative to the sound receiving system 14 according to the directional angle with higher signal power.

In an embodiment, the detection result is related to the target object in the image that matches the location information. In an embodiment, the processor 12 may select one or more video images that match the location information as one or more images to be evaluated. Taking direction as an example of the location information, the processor 12 defines a direction range covering this direction and selects the video images whose fields of view overlap with this direction range as the images to be evaluated. Taking FIG. 3 as an example, 30 degrees to 45 degrees cover the target objects O3 and O4, so the video images VI₁₃ and VI₁₄ are treated as the images to be evaluated.

The processor 12 may detect one or more target objects from one or more images to be evaluated to obtain the detection result. The processor 12 may identify the target objects based on the above-mentioned object detection technology. The detection result further includes that at least one of the target objects is detected or the target objects are not detected.

In an embodiment, the processor 12 may identify the image regions of the target objects from the real-time image captured by the image capturing device 13 and determine whether the image regions that match the location information of the sound source have target objects or determine whether the image regions having the target objects match the location information of the sound source. When the image regions that match the location information of the sound source have target objects or the image regions having the target objects match the location information of the sound source, the processor 12 may determine that multiple target objects are detected. When the image regions that match the location information of the sound source do not have target objects or the image regions having the target objects do not match the location information of the sound source, the processor 12 may determine that the target objects are not detected.

With reference to FIG. 2, the processor 12 selects one or a plurality of target images from the plurality of video images according to the detection result (step S203). To be specific, the detection result of the target objects is used to select one or more of the video images as the target image(s).

In an embodiment, the processor 12 may select one or more video images that match one or more target objects corresponding to the location information as one or more target images. In an embodiment, the processor 12 may select one or more video images that match the location information of the sound source as one or more target images.

In an embodiment, in response to detecting at least one of the plurality of target objects, the processor 12 may select one or more target images from the one or more images to be evaluated. For instance, when a target object is detected from one specific image to be evaluated, the processor 12 treats this image to be evaluated as the target image.

In an embodiment, in response to detecting at least one of the multiple target objects, the processor 12 further determines to treat one or more images to be evaluated as one or more target images according to a duration period of the sound signal emitted by the sound source. Herein, the detection result further includes the duration period. The duration period is the period from when the sound of the sound source is detected by the sound signal. For instance, if user A speaks for 20 seconds, the duration period is 20 seconds. When the duration period increases, the sound source may be considered as the main source, and the level of attention paid to this main source may be increased. For instance, when the duration period is greater than a duration threshold (e.g., 5, 10, or 20 seconds), the image to be evaluated that matches the location information of the sound source may be treated as the target image. When the duration period is not greater than the duration threshold (e.g., 3, 7, or 15 seconds), the image to be evaluated that matches the location information of the sound source is prohibited from being treated as the target image until the duration period is greater than the duration threshold.

In an embodiment, in response to not detecting the target objects, the processor 12 may select one or more target images according to a stop period during which the sound source stops emitting the sound signal. Herein, the detection result further includes the stop period. The stop period is the period during which the sound of the sound source is not detected from the sound signal after the sound of the sound source is detected. For instance, if user B speaks for 10 seconds and then stops speaking for 5 seconds, the stop period is 5 seconds. When the stop period increases, the sound source may be regarded as the secondary source or other sources, and the level of attention paid to this sound source may be lowered.

In an embodiment, in response to the stop period being greater than a stop threshold (e.g., 5, 10, or 20 seconds), the processor 12 may select one or more target images based on the detection result of the one or more video images. Herein, the detection result further includes the number of one or more target objects in one or more video images. Since the stop period is greater than the stop threshold, the previous sound source may be ignored or deleted. Next, the number of target objects present may be used to adjust the allocation of images.

In an embodiment, in response to the number of target objects being greater than a number threshold (e.g., 1 or 2), the processor 12 may integrate the plurality of video images into one target image according to distances among the plurality of target objects in the video images. For instance, when the distance between two target objects is less than a distance threshold (e.g., 50, 70, or 100 cm), the video images of the two target objects may be integrated into one target image through image stitching. When the distance between the two target objects is not less than the distance threshold (e.g., 30, 60, or 90 cm), it is prohibited to integrate the video images of the two target objects into one target image, and the video images of the two target objects are regarded as two target images.

In an embodiment, in response to the number of target objects not being greater than the number threshold (e.g., 1 or 2), the processor 12 may regard all of these video images as target images. For instance, the target object leaves its original position, so that the processor 12 fails to detect the target object.

In an embodiment, the detection result includes the distance between two of the multiple target objects in the multiple video images. The processor 12 may integrate video images corresponding to two of the multiple target objects into one target image according to the distance (regardless of whether the sound of the sound source is detected from the sound signal). For instance, when the distance between two target objects is less than the distance threshold (e.g., 50, 70, or 100 cm), the video images of the two target objects may be integrated into one target image through image stitching. When the distance between the two target objects is not less than the distance threshold (e.g., 30, 60, or 90 cm), it is prohibited to integrate the video images of the two target objects into one target image, and the video images of the two target objects are regarded as two target images.

With reference to FIG. 2, the processor 12 generates a final image according to one or more target images (step S204). To be specific, the final image is the image used to be presented on a user interface. For instance, the image displayed in a live image region of the user interface of a video conferencing program. The final image may include one or more target images. In an embodiment, the processor 12 may synthesize, integrate, or combine one or more target images into the final image. According to the detection result and judgment condition of step S203, the final image may include only the video image acting as the sound source or may include all or part of the video images. The processor 12 may display the final image via a display (not shown). Alternatively, the processor 12 transmits the final image to other devices, and the other devices present the final image.

In an embodiment, the processor 12 may plan a plurality of image regions of the final image according to the number of target images in the final image, and each target image is presented in one image region. The size, location, and shape of the image region may be adjusted as required and are not limited to the embodiments of the disclosure.

Several embodiments are provided in the following paragraphs for description.

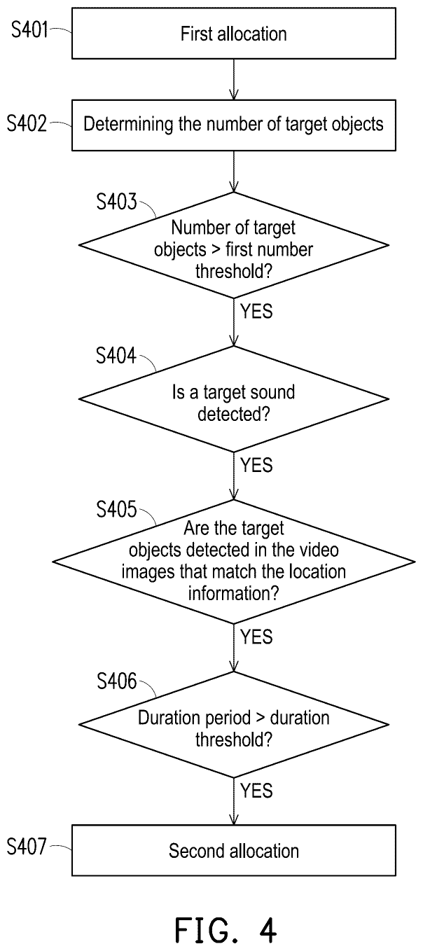

FIG. 4 is a flow chart illustrating switching from the first allocation to a second allocation according to an embodiment of the disclosure. With reference to FIG. 3 and FIG. 4, a final image FI1 shown in FIG. 3 is the first allocation. The final image FI1 presented on the screen 172 (which may also be a display screen) includes the video images VI₁₁ to VI₁₅ corresponding to all the target objects O1 to O5, or the final image FI1 further includes the video image VI₁₆ corresponding to a larger field of view. It is assumed that the user interface of the video conference program initially presents the first allocation (step S401).

The processor 12 determines the number of target objects in the real-time image captured by the image capturing device 13 through the object detection technology (step S402). The processor 12 determines whether the number of the target objects is greater than a first number threshold (e.g., 0) (step S403). As shown in FIG. 3, the number is five. When the number of the target objects is not greater than the first number threshold, the processor 12 treats the real-time image captured by the image capturing device 13 as the final image. Herein, the final image is a general allocation.

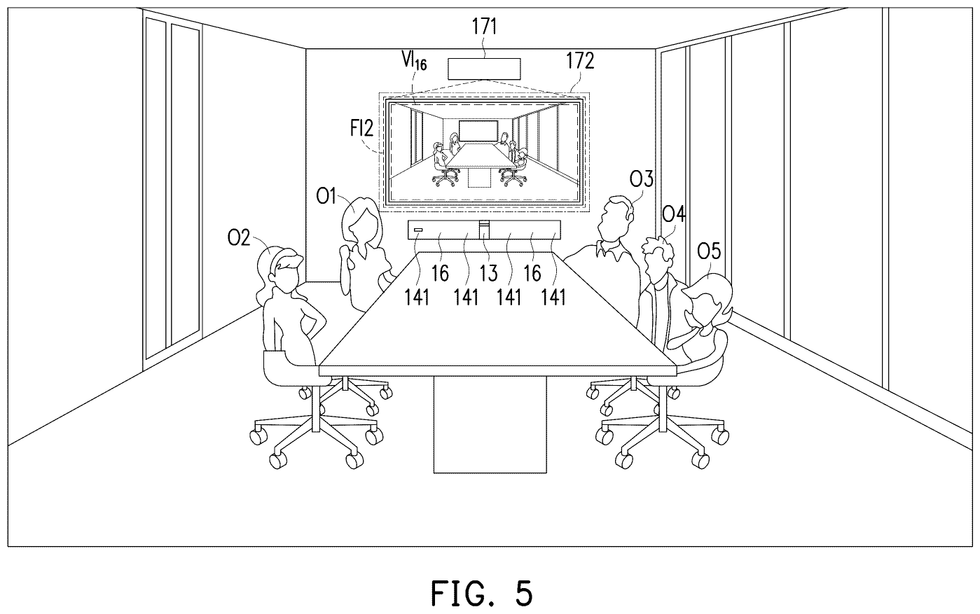

For instance, FIG. 5 is a schematic view illustrating the general allocation according to an embodiment of the disclosure. With reference to FIG. 5, a final image FI2 presented on the screen 172 (which may also be a display screen) includes only the video image VI₁₆ corresponding to the larger field of view.

When the number of the target objects is greater than the first number threshold, the processor 12 determines whether the sound signal detects a target sound (i.e., the sound emitted by the target objects when being treated as the sound source) (step S404). When the target sound is detected, the processor 12 determines the location information of the sound source and determines whether the target objects are detected in the video images matching the location information (step S405). When the target objects are detected from the matched video images, the processor 12 determines whether the duration period of the sound emitted by the sound source is greater than the duration threshold (e.g., 5 seconds) (step S406). When the duration period is greater than the duration threshold, the processor 12 selects only the matched video images as the target images, and the final image includes only the target images. Herein, the final image is the second allocation (step S407).

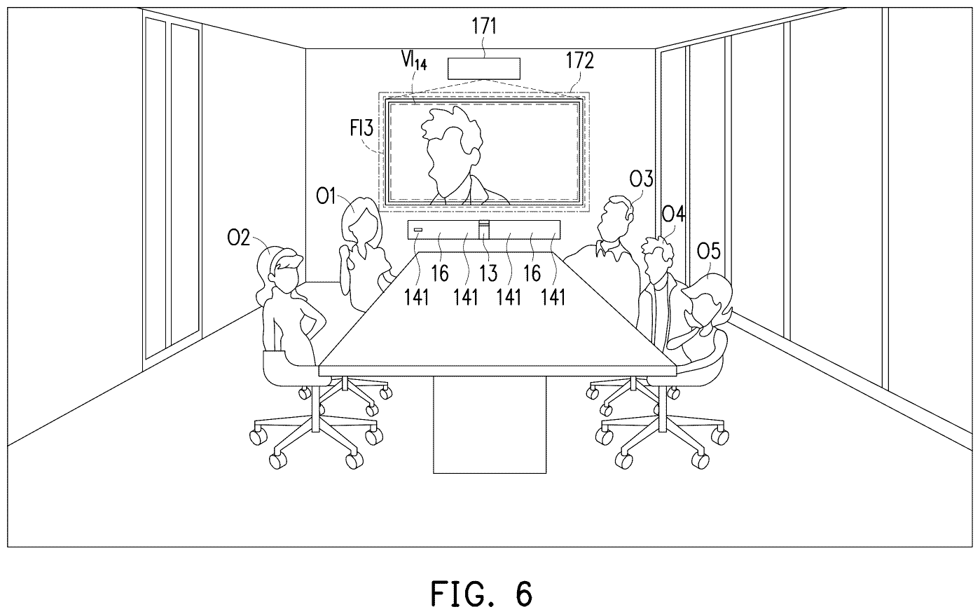

For instance, FIG. 6 is a schematic view illustrating the second allocation according to an embodiment of the disclosure. With reference to FIG. 6, the object O4 made a sound for more than five seconds. Therefore, a final image FI3 presented on the screen 172 (which may also be a display screen) only includes the video image VI₁₄ corresponding to the target object O4.

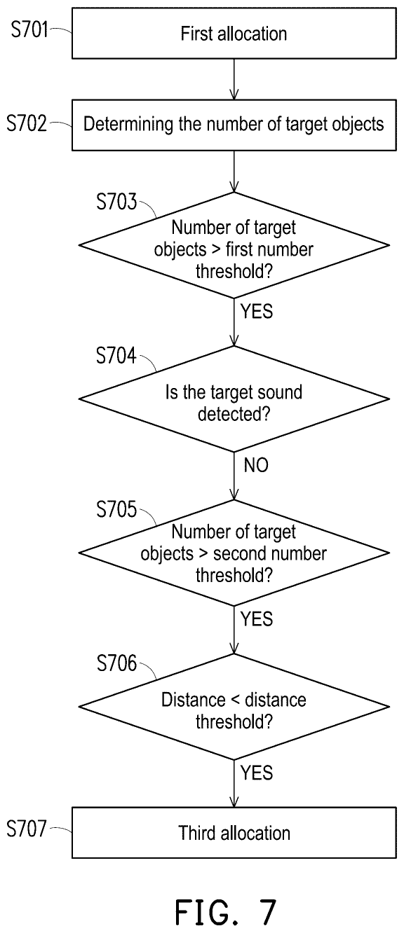

FIG. 7 is a flow chart illustrating switching from the first allocation to a third allocation according to an embodiment of the disclosure. With reference to FIG. 7, description of step S701 to step S704 may be found with reference to the description of step S401 to step S404, so description thereof is not repeated herein.

When the number of the target objects is not greater than the first number threshold (e.g., 0), the processor 12 determines whether the number of the target objects is greater than a second number threshold (e.g., 2) (step S705). When the number of the target objects is greater than the second number threshold, the processor 12 determines whether the distances among the target objects are less than the distance threshold (e.g., 50 cm) (step S706). When the distances among the target objects are less than the distance threshold, the processor 12 integrates the video images corresponding to the multiple target objects whose distances are less than the distance threshold into one target image. Herein, the final image is the third allocation (step S707).

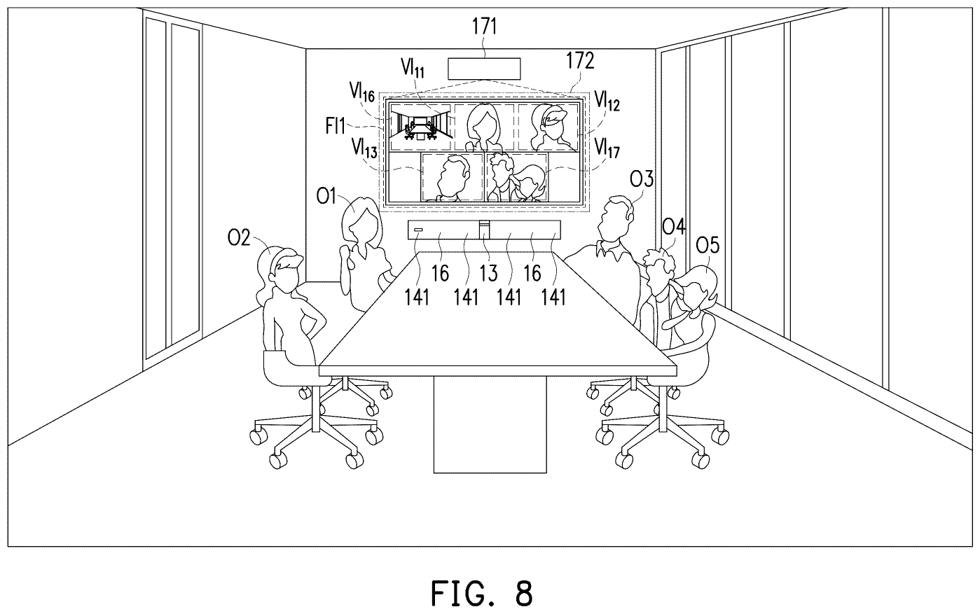

For instance, FIG. 8 is a schematic view illustrating the third allocation according to an embodiment of the disclosure. With reference to FIG. 8, a final image FI4 presented on the screen 172 (which may also be a display screen) includes video images VI₁₁, VI₁₂, VI₁₃, VI₁₆, and VI₁₇. Since the objects O4 and O5 are 40 cm apart, the video image VI₁₇ includes the images of the target objects O4 and O5.

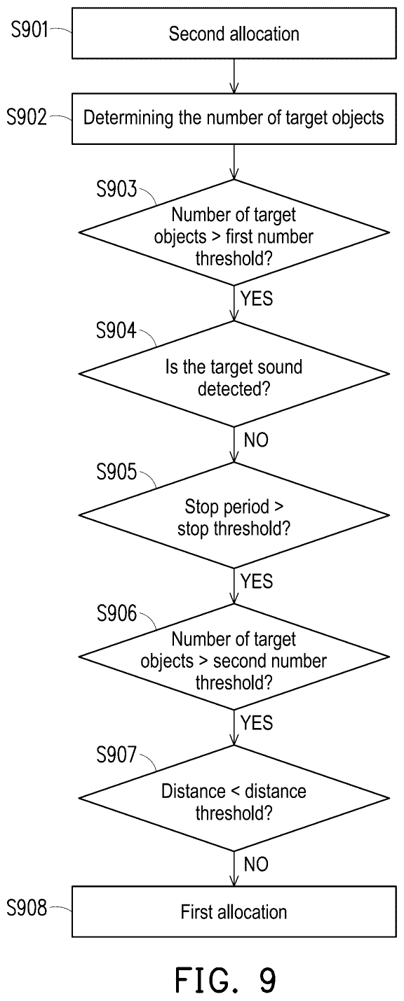

FIG. 9 is a flow chart illustrating switching from the second allocation to the first allocation according to an embodiment of the disclosure. With reference to FIG. 6 and FIG. 9, it is assumed that the user interface of the video conference program initially presents the second allocation (step S901). Description of step S902 to step S904 may be found with reference to the description of step S402 to step S404, so description thereof is not repeated herein.

When the target sound is not detected from the sound signal, the processor 12 determines whether the stop period of the sound source stopping making sound is greater than the stop threshold (e.g., 10 seconds) (step S905). When the stop period is greater than the stop threshold, the processor 12 determines whether the number of the target objects is greater than the second number threshold (e.g., 2) (step S906). When the number of the target objects is greater than the second number threshold, the processor 12 determines whether the distances among the target objects are less than the distance threshold (e.g., 50 cm) (step S907). When the distances among the target objects are not less than the distance threshold, the processor 12 integrates the video images corresponding to the multiple target objects into the final image. Herein, the final image is the first allocation (step S908), as shown in FIG. 3.

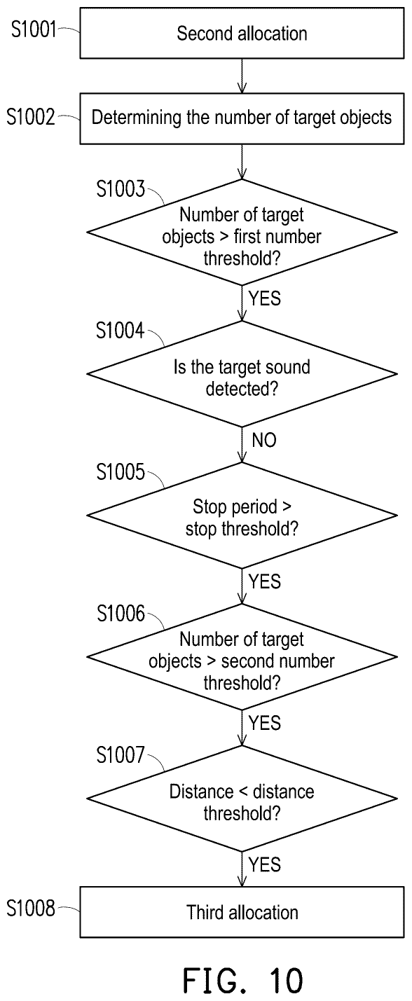

FIG. 10 is a flow chart illustrating switching from the second allocation to the third allocation according to an embodiment of the disclosure. With reference to FIG. 6 and FIG. 10, it is assumed that the user interface of the video conference program initially presents the second allocation (step S1001). Description of step S1002 to step S1004 may be found with reference to the description of step S402 to step S404, and description of step S1005 to step S1007 may be found with reference to the description of step S905 to step S907, so description thereof is not repeated herein.

When the distances among the target objects are less than the distance threshold, the processor 12 integrates the video images corresponding to the multiple target objects whose distances are less than the distance threshold into one target image. Herein, the final image is the third allocation (step S1008).

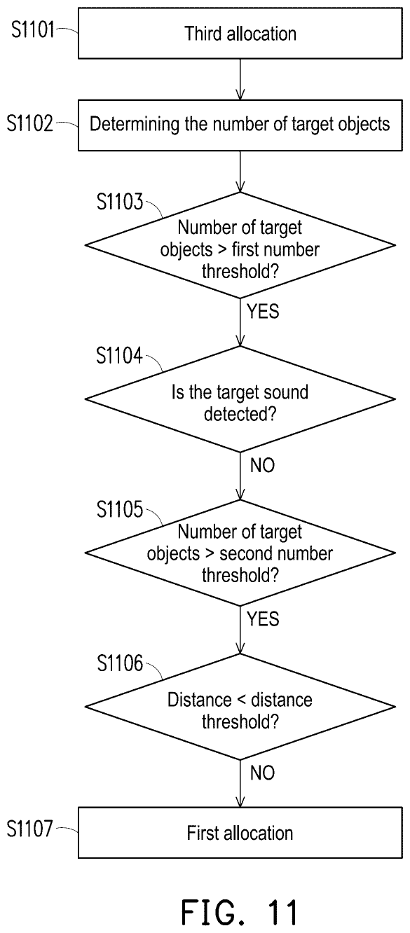

FIG. 11 is a flow chart illustrating switching from the third allocation to the first allocation according to an embodiment of the disclosure. With reference to FIG. 8 and FIG. 11, it is assumed that the user interface of the video conference program initially presents the third allocation (step S1101). Description of step S1102 to step S1104 may be found with reference to the description of step S402 to step S404, so description thereof is not repeated herein.

When the target sound is not detected from the sound signal, the processor 12 determines whether the number of the target objects is greater than the second number threshold (e.g., 2) (step S1105). When the number of the target objects is greater than the second number threshold, the processor 12 determines whether the distances among the target objects are less than the distance threshold (e.g., 50 cm) (step S1106). When the distances among the target objects are not less than the distance threshold, the processor 12 integrates the video images corresponding to the multiple target objects into the final image. Herein, the final image is the first allocation (step S1107), as shown in FIG. 3.

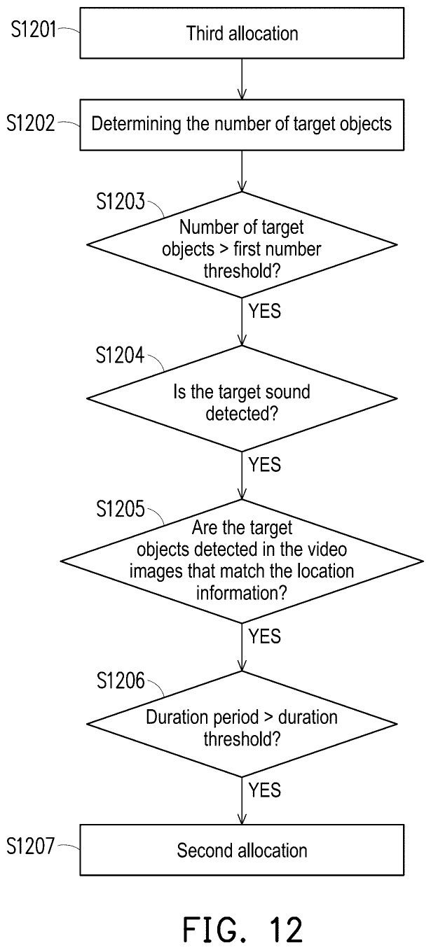

FIG. 12 is a flow chart illustrating switching from the third allocation to the second allocation according to an embodiment of the disclosure. With reference to FIG. 8 and FIG. 12, it is assumed that the user interface of the video conference program initially presents the third allocation (step S1201). Description of step S1202 to step S1206 may be found with reference to the description of step S402 to step S406, so description thereof is not repeated herein.

When the duration period is greater than the duration threshold, the processor 12 selects only the matched video images as the target images, and the final image includes only the target images. Herein, the final image is the second allocation (step S1207), as shown in FIG. 6.

In view of the foregoing, in the allocation method of the video images and the computing apparatus provided by the embodiments of the disclosure, the target image in the final image may be selected based on the location information of the sound source, the target objects detected in the image, and/or the distances among the target objects, and the image allocation in the user interface of the video conferencing program may be changed accordingly. In this way, a flexible screen allocation may be provided, and the level of attention paid to the speaker is also improved.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An allocation method of video images, comprising:
obtaining a plurality of video images corresponding to a plurality of target objects;
obtaining a detection result corresponding to the target objects;
selecting at least one target image from the video images according to the detection result; and
generating a final image according to the at least one target image, wherein the final image is used to be presented on a user interface.

2. The allocation method of the video images according to claim 1, wherein the detection result comprises location information, and the step of selecting the at least one target image from the video images according to the detection result comprises:
selecting at least one of the video images matching at least one of the target objects corresponding to the location information as the at least one target image.

3. The allocation method of the video images according to claim 2, wherein the step of obtaining the detection result corresponding to the target objects comprises:
obtaining a sound signal; and
determining the location information corresponding to a sound source of the sound signal, wherein the sound source is one of the target objects.

4. The allocation method of the video images according to claim 3, wherein the step of obtaining the detection result corresponding to the target objects comprises:
selecting at least one of the video images matching the location information as at least one image to be evaluated; and
detecting at least one of the target objects from the at least one image to be evaluated to obtain the detection result, wherein the detection result further comprises that at least one of the target objects is detected or the target objects are not detected.

5. The allocation method of the video images according to claim 4, wherein the step of selecting at least one of the video images matching at least one of the target objects corresponding to the location information as the at least one target image comprises:
selecting the at least one target image from the at least one image to be evaluated in response to detecting at least one of the target objects; and
selecting the at least one target image according to a stop period during which the sound source stops emitting the sound signal in response to not detecting the target objects, wherein the detection result further comprises the stop period.

6. The allocation method of the video images according to claim 5, wherein the step of selecting the at least one target image from the at least one image to be evaluated comprises:
determining to treat the at least one image to be evaluated as the at least one target image according to a duration period during which the sound source emits the sound signal, wherein the detection result further comprises the duration period.

7. The allocation method of the video images according to claim 5, wherein the step of selecting the at least one target image according to the stop period during which the sound source stops emitting the sound signal further comprises:
selecting the at least one target image according to the detection result of at least one of the video images in response to the stop period being greater than a stop threshold, wherein the detection result further comprises the number of at least one of the target objects in at least one of the video images; and
treating the at least one image to be evaluated as the at least one target image in response to the stop period not being greater than the stop threshold.

8. The allocation method of the video images according to claim 7, wherein the step of selecting the at least one target image according to the detection result of the at least one image to be evaluated comprises:
in response to the number being greater than a number threshold, integrating the video images into one target image according to distances among the target objects in the video images; and
in response to the number being not greater than the number threshold, treating the video images as the at least one target image.

9. The allocation method of the video images according to claim 1, wherein the detection result comprises a distance between two of the target objects in the video images, and the step of selecting the at least one target image from the video images according to the detection result comprises:
integrating the video images corresponding to two of the target objects into one target image according to the distance.

10. The allocation method of the video images according to claim 1, wherein the step of generating the final image according to the at least one target image comprises:
integrating the at least one target image into the final image; and
presenting the final image.

11. A computing apparatus, comprising:
a storage device storing a program code; and
a processor coupled to the storage device, loading the program code, and configured to:
obtain a plurality of video images corresponding to a plurality of photographing regions;
obtain a detection result corresponding to the target object;
select at least one target image from the video images according to the detection result; and
generate a final image according to the at least one target image, wherein the final image is used to be presented on a user interface.

12. The computing apparatus according to claim 11, wherein the detection result comprises location information, and the processor is further configured to:
select at least one of the video images matching at least one of the target objects corresponding to the location information as the at least one target image.

13. The computing apparatus of claim 12, wherein the processor is further configured to:
obtain a sound signal; and
determine the location information corresponding to a sound source of the sound signal, wherein the sound source is one of the target objects.

14. The computing apparatus of claim 13, wherein the processor is further configured to:
select at least one of the video images matching the location information as at least one image to be evaluated; and
detect at least one of the target objects from the at least one image to be evaluated to obtain the detection result, wherein the detection result further comprises that at least one of the target objects is detected or the target objects are not detected.

15. The computing apparatus of claim 14, wherein the processor is further configured to:
select the at least one target image from the at least one image to be evaluated in response to detecting at least one of the target objects; and
select the at least one target image according to a stop period during which the sound source stops emitting the sound signal in response to not detecting the target objects, wherein the detection result further comprises the stop period.

16. The computing apparatus of claim 15, wherein the processor is further configured to:
determine to treat the at least one image to be evaluated as the at least one target image according to a duration period during which the sound source emits the sound signal, wherein the detection result further comprises the duration period.

17. The computing apparatus of claim 15, wherein the processor is further configured to:
select the at least one target image according to the detection result of at least one of the video images in response to the stop period being greater than a stop threshold, wherein the detection result further comprises the number of at least one of the target objects in at least one of the video images; and
treat the at least one image to be evaluated as the at least one target image in response to the stop period not being greater than the stop threshold.

18. The computing apparatus of claim 17, wherein the processor is further configured to:
in response to the number being greater than a number threshold, integrate the video images into one target image according to distances among the target objects in the video images; and
in response to the number being not greater than the number threshold, treat the video images as the at least one target image.

19. The computing apparatus according to claim 11, wherein the detection result comprises a distance between two of the target objects in the video images, and the processor is further configured to:
integrate the video images corresponding to two of the target objects into one target image according to the distance.

20. The computing apparatus of claim 11, wherein the processor is further configured to:
integrate the at least one target image into the final image; and
present the final image.
